(19) United States
(12) Patent Application Publication
(10) Pub. No.: US 2025/0054211 A1
(43) Pub. Date: Feb. 13, 2025

(54) TECHNIQUES FOR USING MACHINE LEARNING MODELS TO GENERATE SCENES BASED UPON IMAGE TILES

(71) Applicant: AUTODESK, INC., San Francisco, CA (US)

(72) Inventors: Frederik BRUDY, Toronto (CA); Fraser ANDERSON, Newmarket (CA); Duong Hai DANG, Munich (DE); George William FITZMAURICE, Toronto (CA)

(21) Appl. No.: 18/649,891

(22) Filed: Apr. 29, 2024

Related U.S. Application Data
(60) Provisional application No. 63/519,203, filed on Aug. 11, 2023.

(51) Int. Cl. G06T 11/20; G06T 7/11

(52) U.S. Cl. CPC G06T 11/203; G06T 7/11

(57) ABSTRACT

In various embodiments, examples of the disclosure provide systems and methods for generating a scene image. A plurality of input image tiles based upon at least one user input are obtained. Spatial positioning of each input image tile included in the plurality of input image tiles relative to at least one other input image tile included in the plurality of input image tiles is detected, and then a scene composition of the scene determined based upon the spatial positioning of each input image tile included in the plurality of image tiles. A scene prompt associated with the scene is obtained, and a machine learning model blends the plurality of image tiles based upon the scene prompt to generate the scene.

### CROSS-REFERENCE TO RELATED APPLICATIONS

This application claims priority benefit of the United States Provisional patent application titled “ITERATIVE AND EXPRESSIVE PROMPTING FOR WORLD BUILDING USING GENERATIVE ARTIFICIAL INTELLIGENCE,” filed on Aug. 11, 2023, and having Ser. No. 63/519,203. The subject matter of this related application is hereby incorporated herein by reference.

### BACKGROUND

### Field of the Various Embodiments

The various embodiments relate generally to computer-aided design and artificial intelligence and, more specifically, to techniques for using machine learning models to generate scenes based upon input image tiles.

### Description of the Related Art

Creating scenes or unique environments in fictional worlds generally involves significant time and skill on behalf of an artist. Creation generally involves an overall design process during which an artist first conceives of an idea of a scene in a fictional world and then engages in a potentially time-consuming process of creation of the scene. Some artists might have a level of expertise with computer-aided design tools in which electronic representations of a scene can be created. As is well-understood in practice, manually generating numerous scenes to build a fictional world can be very labor-intensive and time-consuming. Because fictional worlds that are used in games and storytelling can require a multitude of scenes, individual creators might expend a great deal of time to create a single fictional world, which can reduce the quality and/or output of the creator. Accordingly, various conventional computer-aided design tools have been developed that attempt to automate certain aspects of the creative process.

Certain applications for automating some aspects of the creative process for creating scenes of a fictional world involve domain-specific tools. For example, terrain generation tools can procedurally generate varied terrains based upon a fixed set of rules or grammar. With such a tool, terrain can be automatically generated according to parameters or rules specified by the creator. However, such a tool only generates terrain and only procedurally.

Other examples of tools available to creators include 3D world and game level creation tools. However, again, these tools operate procedurally, preventing users from defining a fictional world using a higher-level semantic description. If a user lacks the underlying know-how required to create scenes of a fictional world utilizing a computer-aided design tool, the artist may waste significant time and effort to create the fictional world or may abandon the creative process altogether.

Generative tools can be utilized to create images based upon natural language textual prompts to guide the image generation process semantically. However, most generative models are limited to a single-use or “click once” text prompt interface that outputs what the model is trained to believe is a finished product. Such an approach requires the artist to provide a complete and accurate semantic description of the desired scene up front. However, fictional world building is often an iterative process, where the creativity of the artist is expressed in a step-by-step creative flow. Creators of scenes in a fictional world often express creativity by sketching or storyboarding and then creating scenes based on the initial ideas.

As the foregoing illustrates, what is needed in the art are more effective techniques for generating scenes of a fictional worlds.

### SUMMARY

One embodiment sets forth a computer-implemented method for generating a scene. In some embodiments, the method includes obtaining a plurality of input image tiles based upon at least one user input, detecting a spatial positioning of the plurality of input image tiles relative to one another, determining a scene composition of the scene based upon the spatial positioning of the plurality of image tiles relative to one another, obtaining a scene prompt associated with the scene, and executing a first machine learning model to blend the plurality of image tiles to form the scene based upon the scene prompt.

At least one technical advantage of the disclosed techniques relative to the prior art is that the disclosed techniques enable users with limited time or knowledge of computer-aided design tools or generative tools to generate scenes of a fictional world more effectively and efficiently. In that regard, the disclosed techniques provide an automated process for obtaining multiple image tiles that can be used as the basis for generating a scene of a fictional world. The image tiles can be provided by a user or created using a machine learning model that is provided a user input, such as a textual prompt, a sketch, a region map based upon user-designated regions of an image tile, or any combination thereof. The machine learning model can generate one or more image tiles based upon the user input from a spatial relationship of the image tiles with respect to one another and a textual scene prompt obtained from a user.

Accordingly, with the disclosed techniques, scenes that align better with the artistic intentions of users can be more readily generated and manufactured. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments.

FIGS. 2-10 are example illustrations of graphical user interfaces depicting how a scene creation application can be used to generate a scene, according to various embodiments.

FIG. 11 sets forth a flow diagram of method steps for generating a scene using the scene creation application, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances of like objects are symbolized with reference numbers identifying the object and parenthetical numbers(s) identifying the instance where needed.

### System Overview

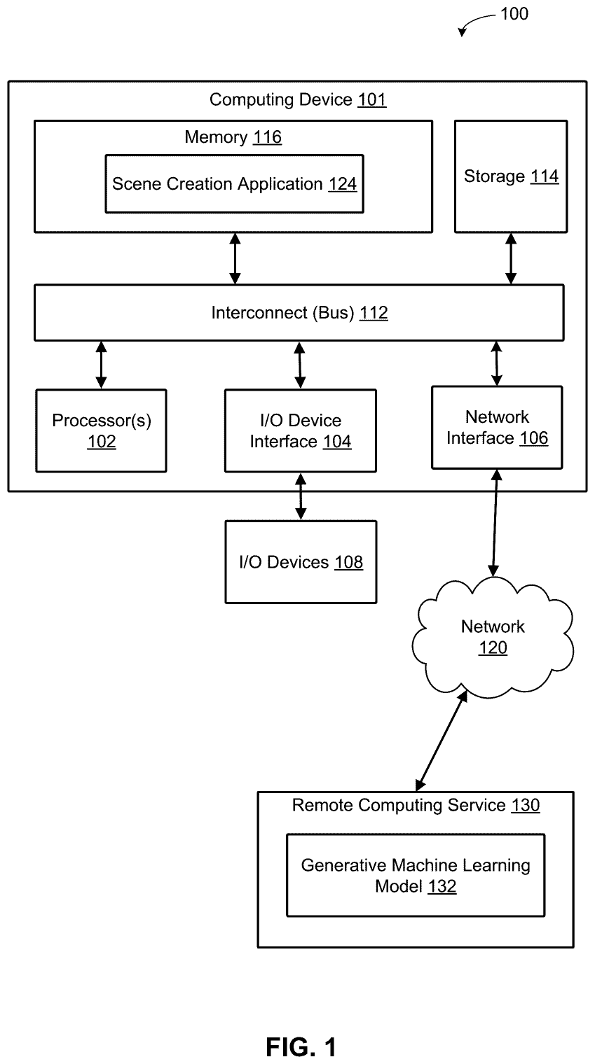

FIG. 1 illustrates a system 100 configured to implement one or more aspects of the various embodiments. The system can include a computing device 101 and a remote computing device 130 in communication via a network 120. The computing device 101 includes a desktop computer, a laptop computer, a smart phone, a personal digital assistant (PDA), tablet computer, or any other type of computing device configured to receive input, process data, and optionally display images, and is suitable for practicing one or more embodiments. Computing device 101 is configured to run a scene creation application 124 that reside in a memory 116.

It is noted that the computing device described herein is illustrative and that any other technically feasible configurations fall within the scope of the present disclosure. For example, multiple instances of the scene creation application 124 could execute on a set of nodes in a distributed and/or cloud computing system to implement the functionality of computing device 101. In another example, the scene creation application 124 could execute on various sets of hardware, types of devices, or environments to adapt scene creation application 124 to different use cases or applications.

In one embodiment, computing device 101 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 101 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 101, and to also provide various types of output to the end-user of computing device 101, such as displayed digital images or digital videos or text. In some embodiments, one or more of I/O devices 108 are configured to couple computing device 101 to a network 120.

Network 120 is any technically feasible type of communications network that allows data to be exchanged between computing device 101 and external entities or devices, such as a web server or another networked computing device. For example, network 120 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Scene creation application 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including scene creation application 124.

In general, the computing device 101 is configured to implement one or more software applications. For explanatory purposes only, each software application is described as residing in the memory 116 of the computing device 101 and executing on the processor 102 of the computing device 101. In some embodiments, any number of instances of any number of software applications can reside in the memory 116 and any number of other memories associated with any number of other compute instances and execute on the processor 102 of the computing device 101 and any number of other processors associated with any number of other compute instances in any combination. In the same or other embodiments, the functionality of any number of software applications can be distributed across any number of other software applications that reside in the memory 116 and any number of other memories associated with any number of other compute instances and execute on the processor 102 and any number of other processors associated with any number of other compute instances in any combination. Further, subsets of the functionality of multiple software applications can be consolidated into a single software application.

In particular, the computing device 101 is configured to generate scenes according to user inputs provided by a user. As described previously herein, one conventional approach to generating scenes involves a manual process with limited automation and limited support for an iterative creative process that is often preferred by creators. In operation, the embodiments of the disclosure can automatically generate scenes of a fictional world based upon input image tiles that are provided by a user or created using a generative machine-learning model based upon user inputs. The Embodiments of the disclosure can allow the user to define a spatial relationship between image tiles with respect to each other and provide an additional textual prompt, or a scene textual prompt. Using the image tiles, the spatial relationship of the image tiles with respect to each other, and the scene textual prompt as inputs, a machine learning model can be executed that generates a scene.

Remote computing device 130 represents one or more computing devices that provide computing services that can be accessed by the computing device 101 via the network 120. The remote computing device 130 can be implemented computing devices that include, without limitation, one or more processors and a network interface coupled to the network 120. In the context of this disclosure, the elements shown in remote computing device 130 may correspond to a physical computing system (e.g., a system in a data center) or may be a virtual computing instance executing within a computing cloud.

The remote computing device 130 can provide access to a generative machine learning model 132. The generative machine learning model 132 can comprise a machine learning model that can generate one or more images based upon inputs, such as prompts, can are provided to the model. The generative machine learning model 132 can generate images based upon textual prompts, image prompts, or a combination of text and images that are provided as inputs to the model. The generative machine learning model 132 can comprise a deep learning, text-to-image model that can apply various techniques to generate imagery based upon textual inputs. For example, the generative machine learning model 132 can employ a diffusion model that utilizes a deep generative artificial neural network to generate images from textual inputs or from images that are provided as inputs. For example, the generative machine learning model 132 can generate an image from text alone or modify imagery provided to the generative machine learning model 132 as an input. Additionally, the generative machine learning model 132 can modify or transform imagery provided as an input according to a textual prompt that is provided in combination with the input imagery. In some implementations, the generative machine learning model 132 can utilize a transformer architecture to generate images from a textual prompt or to modify images based upon a textual prompt provided along with an input images.

For example, generative machine learning model 132 can comprise a machine learning model that has been trained on a relatively large amount of existing textual data and a relatively large amount of existing image data to generate new image data in response to text prompts that are optionally associated with any number and/or types of image prompts. And because the generative machine learning model 132 generates new image data, the generative machine learning model 132 can be referred to as a generative prompt-to-image machine learning model.

In some embodiments, the generative machine learning model 132 comprises a specialized version of a GPT-3 model referred to as a “DALL-E2” model. Techniques for implementing and using different multimodal ML models to generate new image data in response to text prompts that are optionally associated with image prompts are well-known in the art. For example, please see https://openai.com/dall-e-2 for information on implementing and using DALL-E2. In some other embodiments, the generative machine learning model 132 is trained to generate new image data in response to text prompts but does not process image prompts, and the techniques described herein are modified accordingly. Another example of a generative machine learning model 132 can include the Stable Diffusion machine learning model. For example, please see https://github.com/Stability-AI/generative-models.

It should be appreciated that in some implementations, more than one type of generative machine learning model 132 can be utilized to generate one or more images based upon inputs provided to the remote computing device 130. Additionally, more than one remote computing device 130 can be utilized to generate images based upon textual or image prompts provided as inputs. In the context of this disclosure, as is described in more detail herein, the scene creation application 124 can provide textual or image-based inputs to the generative machine learning model 132, which can generate one or more output images that can be utilized to generate a scene on behalf of a user of the scene creation application 124. Additionally, in some implementations, the generative machine learning model 132 can be implemented on the same computing device 101 on which the scene creation application 124 is executing. For example, the generative machine learning model 132 can be implemented as a module or functionality that is embedded within the scene creation application 124.

It will be appreciated that the system 100 shown herein is illustrative and that variations and modifications are possible. For example, the functionality provided by scene creation application 124 and the generative machine learning model 132 as described herein can be integrated into or distributed across any number and/or types of software applications (including one), and any number of components of the system 100. Further, the connection topology between the various units in FIG. 1 can be modified as desired.

Please note that the techniques described herein are illustrative rather than restrictive and can be altered without departing from the broader spirit and scope of the embodiments. Many modifications and variations on the functionality of the generative machine learning model 132 and the scene creation application 124 as described herein will be apparent to those of ordinary skill in the art without departing from the scope and spirit of the described embodiments.

Similarly, the storage, organization, amount, and/or types of data described herein are illustrative rather than restrictive and can be altered without departing from the broader spirit and scope of the embodiments. In that regard, many modifications to the data displayed within the various GUI's as described herein will be apparent to those of ordinary skill in the art without departing from the scope and spirit of the described embodiments.

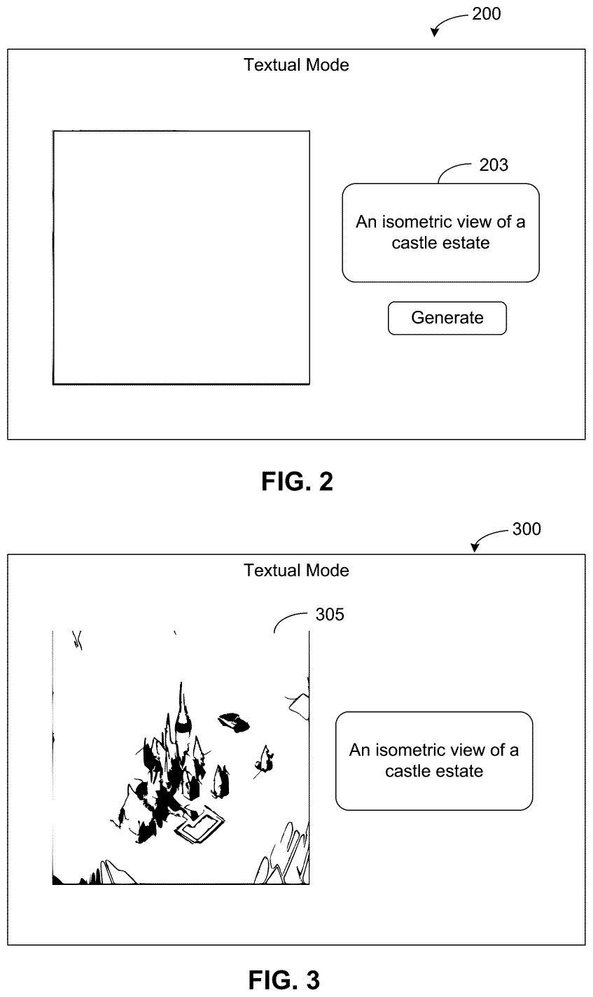

The scene creation application 124 is described in further detail in conjunction with FIGS. 2-10.

Generating Image Tiles from User Inputs

To address the above problems, the system 100 includes, without limitation, a scene creation application 124. As described in greater detail below, the scene creation application 124 interacts with a user via a graphical user interface (GUI) in order to obtain or generate one or more image tiles that can be utilized to define a scene composition. From the scene composition that is identified by the scene creation application 124 a scene can be created using the generative machine learning model 132. In other words, the scene creation application 124 can cause the generative machine learning model 132 to be executed to generate an output image representing the generated scene based upon input image tiles and textual scene prompts that are provided as inputs to the generative machine learning model 132.

To generate scenes on behalf of a user, the scene creation application 124 obtains one or more image tiles from which a scene composition is determined. Accordingly, the GUI 200 of FIG. 2 illustrates one example of how a user can generate or provide an image tile as an input to the generative machine learning model 132.

The GUI 200 and any subsequent GUIs depicted and described herein can be any type of user interface that allows users to interact with one or more software applications via any number and/or types of GUI elements. The GUI 200 can be displayed in any technically feasible fashion on any number and/or types of stand-alone display device, any number and/or types of display screens that are integrated into any number and/or types of user devices, or any combination thereof. A user device can be any device that can display any amount and/or type of media content on one or more associated display devices, one or more associated display screens, or any combination thereof. Some examples of user devices include desktop computers, laptops, smartphones, smart televisions, and tablets.

In the example shown in GUI 200, the scene creation application 124 can allow the user to enter a textual mode for generating image tiles. In a textual mode, the scene creation application 124 can prompt the user to provide a textual prompt from which an image tile can be generated by the generative machine learning model 132. The scene creation application 124 can generate an image tile by providing the textual prompt provided by the user to generative machine learning model 132.

Accordingly, as shown in FIG. 2, the user can provide the image tile textual prompt 201 into a text input user interface element 203, and the scene creation application 124 can execute the generative machine learning model 132 with the textual prompt as an input to request one or more output images based upon the textual prompt. The image tile textual prompt 201 can describe a desired trait or characteristic of the image tile, or text that describes an idea that the artist intends or desires to depict in an image tile. In the example of FIG. 2, the image tile textual prompt 201 describes “an isometric view of a castle estate,” which is a textual input that the scene creation application 124 can provide to the generative machine learning model 132. The scene creation application 124 can execute or cause the generative machine learning model 132 to be executed to generate one or more output images that can be presented to the user as an image tile from which a scene can be later created by the scene creation application 124.

Continuing the example of FIG. 2, reference is now made to FIG. 3, which illustrates GUI 300. In GUI 300, the scene creation application 124 has executed the generative machine learning model 132 to generate an image tile 305 based upon the image tile textual prompt 201 provided by the user. In some cases, the scene creation application 124 can request and the generative machine learning model 132 can generate multiple output images based upon the image tile textual prompt 201. The multiple images can be presented to the user via the GUI 300 as image tile candidates from which the user can select to generate a particular image tile.

Accordingly, the GUI 300 of FIG. 3 illustrates how the scene creation application 124 can execute the generative machine learning model 132 to generate an image tile 305 based upon the text input user interface element 203 provided by the user in GUI 200. In some implementations, the scene creation application 124 can permit the user to further edit generated image tile 305 with image editing tools provided by the scene creation application 124. In other examples, the user can accept the generated image tile 305 as one of the plurality of image tiles that can be utilized as inputs to a process for generating a scene from multiple image tiles.

Generating image tiles based upon an image tile textual prompt 201 as shown in FIGS. 2-3 is an example of a particular mode of image tile creation, referred to herein as a textual mode. In some cases, the scene creation application 124 can allow the user to start textual mode when a previously created or user provided image tile. In this scenario, the user can provide an image tile textual prompt 201 along with a previously created image tile. In this scenario, the previously created image tile and the image tile textual prompt 201 can be provided as inputs to the generative machine learning model 132 to create a new image tile.

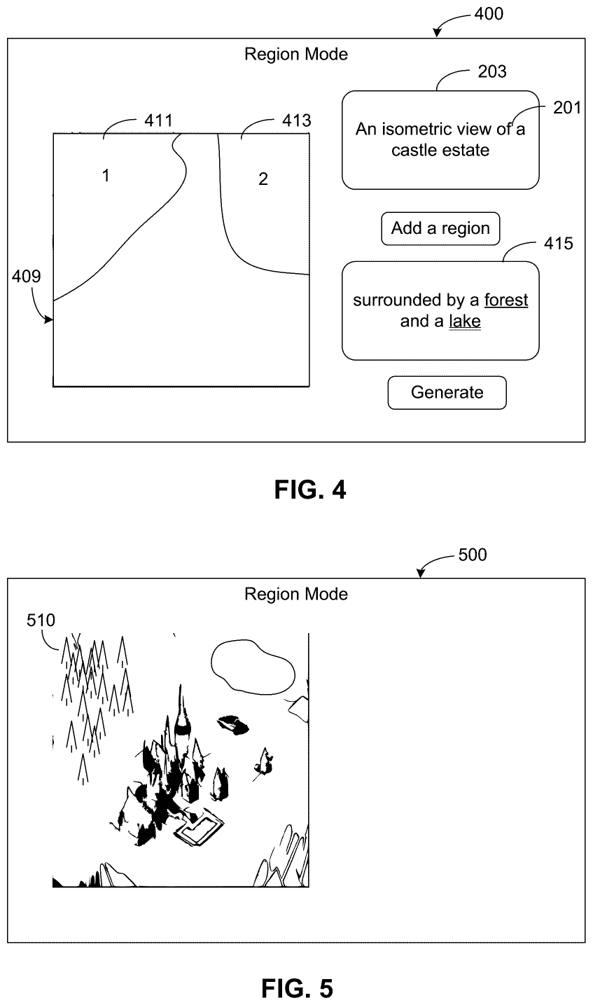

Examples of the scene creation application 124 can provide a multi-modal system for generating image tiles and scenes. Accordingly, reference is now made to FIG. 4, where example GUI 400 is shown. In the GUI 400 of FIG. 4, a region mode for creating image tiles that can be provided by the scene creation application 124 is shown.

In the example of FIG. 4, the GUI 400 illustrates a region mode mechanism for generating image tiles that can be provided by the scene creation application 124. In the depicted GUI 400, the scene creation application 124 can allow the user to enter a region mode for creating image tiles. In the region mode, the user can designate one or more regions of a blank canvas. In an alternative example, the user can designate one or more regions of a previously generated or user-provided image tile.

The scene creation application 124 can provide a user interface mechanism whereby the user can draw, sketch, or otherwise elect regions of a blank canvas or a previous image tile. Additionally, the scene creation application 124 can allow the user to provide textual prompts that are associated with the regions designated within the image tile. As shown in FIG. 4, the user can provide a text input user interface element 203 that can describe an artist's overall intention for an image tile. Next, the scene creation application 124 can allow the artist to specify a region textual prompt 415 that specifies a textual prompt that is specific to regions of the image, which are denoted by region 411 and region 413.

In one example user interaction, the scene creation application 124 can allow a user to sketch or draw a region in an image tile area 409, such as region 411, and then specify a region textual prompt 415, where different portions of the region textual prompt 415 are associated with the specific regions 411 and 413. In the example shown in FIG. 4, the portion of the region textual prompt 415 associated with region 411 is underlined and the portion of the region textual prompt 415 associated with region 413 is denoted with double-underline. In another example, a first region sketched or identified by the user can be denoted by a first color in the image tile area 409, and a different region sketched or identified by the user can be denoted by a second color in the image tile area 409. Correspondingly, the portion of the region textual prompt 415 that corresponds to the first region can be denoted with the same color in the image tile area 409. Similarly, the portion of the region textual prompt 415 corresponding to the second region can be denoted with the same color as the second region in the image tile area 409.

Returning to the GUI 400 of FIG. 4, once the user has sketched or identified regions with the image tile area 409 as well as specified a region textual prompt 415, the user can request the scene creation application 124 to generate the image tile. Accordingly, reference is made to FIG. 5, which illustrates a GUI 500 that can be provided by the scene creation application 124. The GUI 500 shows an example of an image tile 510 that can be generated by the scene creation application 124. The image tile 510 can be generated based upon the region definitions captured in the GUI 400 of FIG. 4, the user sketch in the image tile area 409, and the region textual prompt 415. The region definitions captured in the GUI 400 of FIG. 4, the user sketch in the image tile area 409, and the region textual prompt 415 can be provided to the generative machine learning model 132, which can generate one or more output image, which can be presented to the user via the GUI 500.

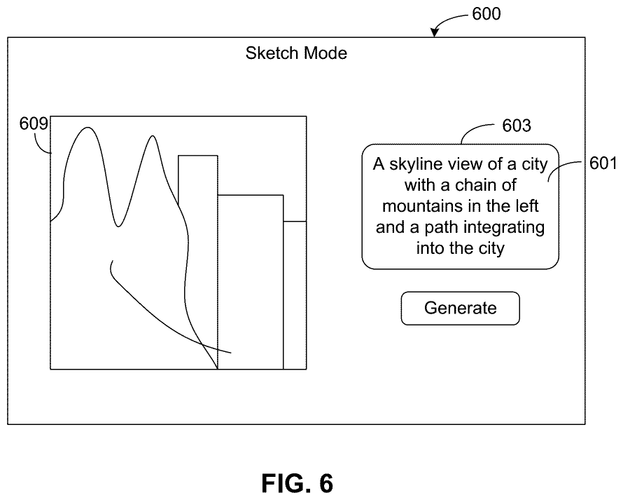

Referring next to FIG. 6, shown is GUI 600. GUI 600 can be provided by the scene creation application 124 to provide an alternative tile creation mode, referred to herein as sketch mode. In the example of FIG. 6, the scene creation application 124 can allow the user to provide a sketch from which the scene creation application 124 can execute the generative machine learning model 132 to generate one or more image tiles that can later be used to generate a scene. As shown in FIG. 6, the user can input a sketch into the image tile area 609. Additionally, the GUI 600 can allow the user to provide an image tile textual prompt 601 using a text input user interface element 603. The image tile textual prompt 601 can be used by the scene creation application 124 to generate an image tile from the sketch inputted by the user into the image tile area 609.

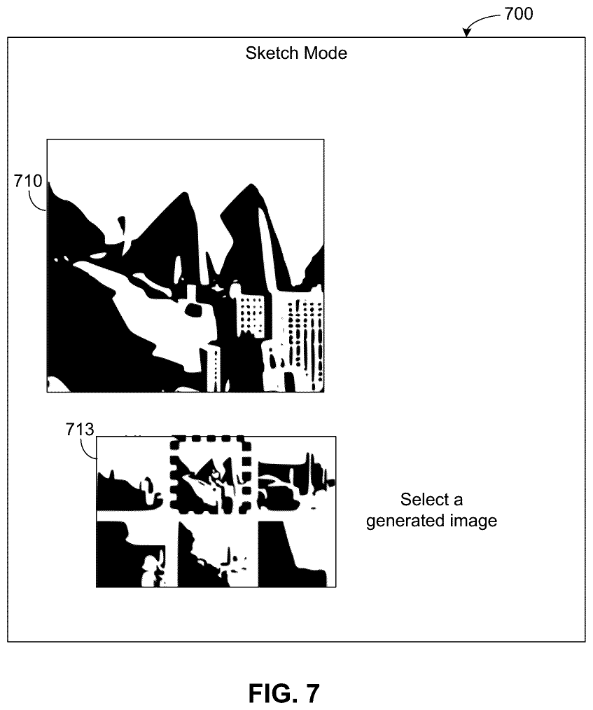

Reference is now made to FIG. 7, which continues the example of FIG. 6 and illustrates an example of how the scene creation application 124 can generate multiple image tile candidates from which a user can select. FIG. 7 illustrates a GUI 700 that can be generated by the scene creation application 124. The scene creation application 124 can generate multiple image tile candidates in any of the scene tile creation modes, such as sketch mode, region mode, or textual mode. The image tile candidates can be presented in an image tile selector within a GUI provided by the respective scene tile creation mode such as in the example shown in FIG. 7.

In the example of FIG. 7, the user can select one of the image tile candidates in the image tile selector 713, which can cause the scene creation application 124 to show the image tile 710 in the GUI 700. The image tile candidates shown in the image tile selector 713 can be generated by the scene creation application 124. The scene creation application 124 can provide the sketch obtained from the GUI 600 of FIG. 6 and execute the generative machine learning model 132, providing the image tile textual prompt 601 and the sketch as inputs. The generative machine learning model 132 can generate one or more output images based upon the inputs, which can be presented as image tile candidates in the image tile selector 713.

It should be appreciated that the scene creation application 124 can present multiple image tile candidates in an image tile selector 713 in any of the image tile creation modes. Additionally, the image tile creation modes can be presented in a combined manner so that a user can input textual prompts, define regions, and input a sketch into a single user interface from which the scene creation application 124 can capture the user inputs to be provided to generative machine learning model 132 to generate image tiles. Additionally, in some scenarios, the image tiles can be uploaded or provided by the user and can comprise previously generated images that are associated with an archive that is stored on the computing device 101 or accessible to the scene creation application 124. The archive can be associated with the user or a session of the user in which the user has generated or provided image tiles to be incorporated into a scene.

For scene descriptions without additional input, such as in the depicted textual mode, the scene creation application 124 can generate an image from random noise based on the provided textual input. Should a user opt to utilize sketch mode or region mode provided by the scene creation application 124 by inputting a sketch such as an RGB sketch, the scene creation application 124 can utilize the sketch as well as Gaussian noise to generate an input image for the generative machine learning model 132 that matches user sketch. Regions that are defined or specified by the user can be provided to the generative machine learning model 132 as an array, with each entry containing a binary mask image along with the corresponding textual input for respective regions.

In the sketch or region modes, the scene creation application 124 can extract multiple binary masks from user-provided region segmentation, where pixels of a first color correspond to the unique region color, and the remaining area is designated with a second color. A separate binary image mask can be generated, with dimensions matching the output image, and with each word in an input text prompt. Notably, words in the user-provided text input exert variable influence on different parts of the image, with pixels of the first color serving as indicators for a higher probability of an element appearing in the assigned segment.

In some examples, the user can modify or further refine respective image tiles that are generated using the scene creation application 124 before selecting the image tile to form a scene using the scene creation application 124. For example, if an image tile generated by the scene creation application 124 using the generative machine learning model 132 does not fully meet the expectations of the artist, the artist can select the image tile and provide an additional textual prompt, user sketch, and/or region designations on the image tile, which are user inputs that can be provided by the scene creation application 124 to the generative machine learning model 132. The generative machine learning model 132 can modify the image tile based upon the user inputs to generate a new image tile.

Additionally, the scene creation application 124 can maintain a history of previously selected and generated image tiles so that the user can access a historical record of image tiles generated using the scene creation application 124 for a given session or a given user's history with the scene creation application 124. The user can select or modify historical image tiles to create new image tiles for scenes that the user wishes to generate using the scene creation application 124.

Generating Scenes from Image Tiles

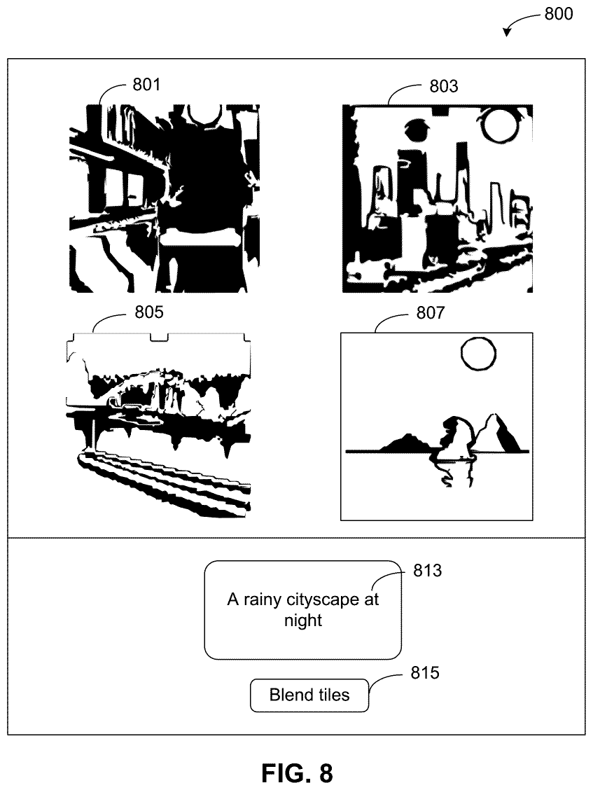

Referring now to FIG. 8, shown is an example GUI 800 that can be generated by the scene creation application 124. The GUI 800 can be referred to herein as a global image tile view. In the example GUI 800 shown in FIG. 8, multiple image tiles are shown. The scene creation application 124 can require the user to select or generate multiple image tiles from which a scene can be generated by the scene creation application 124 on behalf of the user. In the depicted example, the scene creation application 124 can allow the user to select up to four image tiles from which a scene can be generated. However, in other implementations, the scene creation application 124 can allow or require the user to select or generate more or fewer image tiles from which a scene can be generated.

The image tiles 801, 803, 805, and 807 can be provided by the user or generated by the scene creation application 124 based upon textual, region, or sketch prompts provided by the user and then in turn provided to the generative machine learning model 132 to generate image tiles. In some examples, one or more of the image tiles can be uploaded or selected by the user from a preexisting library of image tiles. The preexisting library of image tiles can be stored on the computing device 101 or obtained from a remote source, such as an image library that is accessible via the network 120.

The scene creation application 124 can determine a spatial relationship of the image tiles selected by the user for a given scene with respect to one another and generate a scene from the image tiles and the spatial relationship. In some examples, such as the example depicted in GUI 800, the user can arrange the image tiles 801, 803, 805, and 807 in a grid format in which the image tiles are equidistantly spaced. The user can click and drag each image tile in the GUI 800 to a desired location to define the spatial relationship of the image tiles 801, 803, 805, and 807 with respect to each other. The spatial relationship of the image tiles 801, 803, 805, and 807 with respect to each other also defines the scene composition of a resulting scene that is generated by the scene creation application 124.

The scene creation application 124 can also allow the user to provide a scene textual prompt 813 describing a desired characteristic or trait of a scene that the user wishes to create using the scene creation application 124. In the depicted example, the scene textual prompt 813 can be provided to the scene creation application 124 via the GUI 800. Upon providing the scene textual prompt 813 and the image tiles 801, 803, 805, and 807, the user can cause the scene creation application 124 to generate a scene based upon the image tiles 801, 803, 805, and 807 as well as the scene textual prompt 813 by activating the blend tiles user interface element 815.

Upon activating the blend tiles user interface element 815, the scene creation application 124 can provide the scene textual prompt 813, the image tiles 801, 803, 805, and 807, and the spatial relationship of the image tiles with respect to one another as inputs to the generative machine learning model 132. In other words, the scene creation application 124 can execute the generative machine learning model 132 or cause the generative machine learning model 132 to be executed to generate an output image using the image tiles 801, 803, 805, and 807, the scene textual prompt 813, and the spatial relationship of the image tiles with respect to one another as inputs. The spatial relationship of the image tiles with respect to one another can be expressed as a bitmap that identifies the respective image tiles and coordinate positions of the image tiles on a cartesian grid, for example. The generative machine learning model 132 can generate an output image that can be provided to the scene creation application 124, which can present the output image as a scene generated on behalf of the user by the scene creation application 124.

The scene creation application 124 can generate the output image corresponding to a scene by filling the white space between the image tiles 801, 803, 805, and 807 and blending the tiles together. For blending image tiles, the scene creation application 124 can, for example, obtain a binary mask with black pixels for image tiles and white pixels for empty space. A Gaussian blur can be applied to the mask, softening black tile edges for a smooth blend. The final image corresponding to a scene can be generated by inputting the mask and user-created image tiles 801, 803, 805, and 807 as inputs to the generative machine learning model 132.

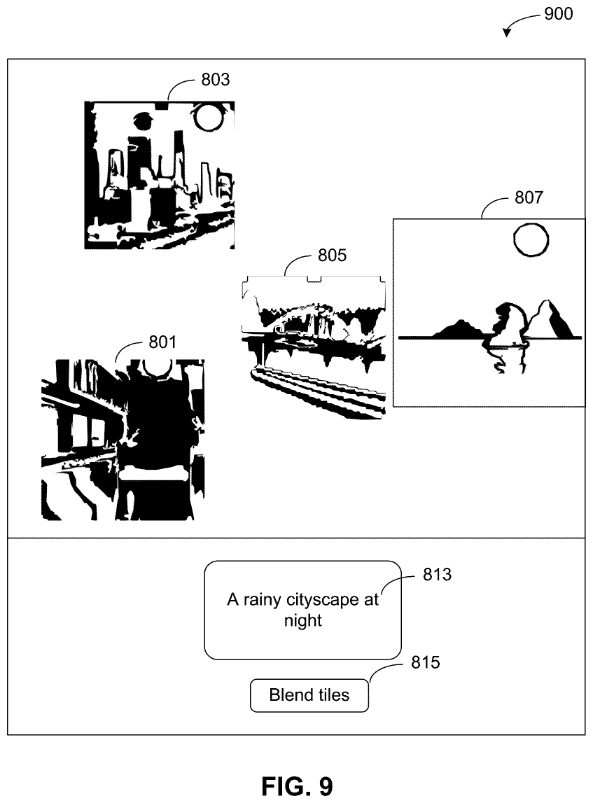

Referring next to FIG. 9, shown is an alternative example of a GUI 900 that can be generated by the scene creation application 124. In the example GUI 900 of FIG. 9, the user has rearranged the image tiles 801, 803, 805, and 807 within the GUI 900 to change the spatial orientation of the image tiles with respect to one another. By rearranging the image tiles, the scene composition of a resultant scene has been altered.

Again, the user can provide a scene textual prompt 813 and request the scene creation application 124 to generate a scene based upon the image tiles 801, 803, 805, and 807 and scene composition by activating the blend tiles user interface element 815, which can cause the scene creation application 124 to execute the generative machine learning model 132 to generate an output image as the scene.

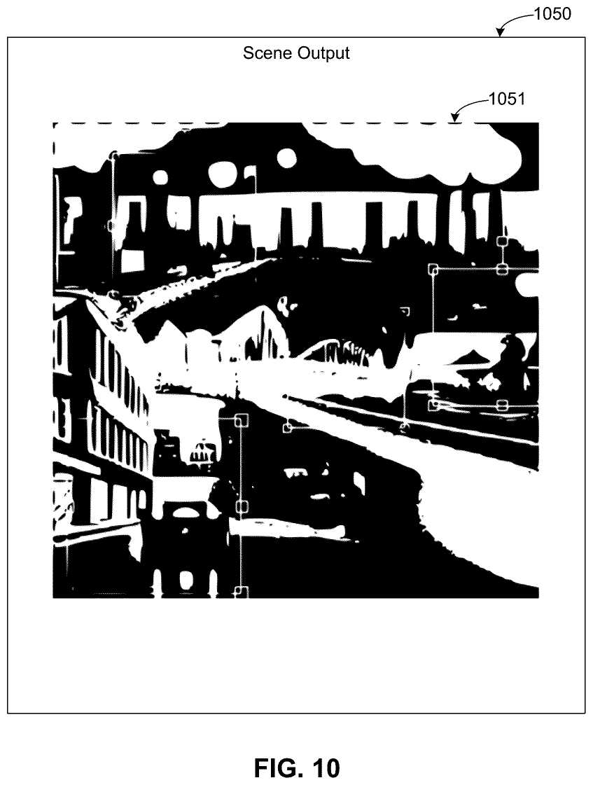

Continuing the example of FIG. 9, reference is now made to FIG. 10. FIG. 10 illustrates a GUI 10501050 that shows an example scene that can be generated by the scene creation application 124 based upon the image tiles 801, 803, 805, and 807, the scene composition, and the scene textual prompt 813. The scene 1051 can be generated by blending the image tiles 801, 803, 805, and 807 and filling the white space between the image tiles using the scene textual prompt 813. The spatial positioning of the image tiles 801, 803, 805, and 807 can remain largely unchanged, while the generative machine learning model 132 can fill the whitespace with image content and blend the image tiles 801, 803, 805, and 807 with the image content generated to fill the whitespace.

As persons skilled in the art will recognize, the techniques described herein are illustrative rather than restrictive and can be altered and applied in other contexts without departing from the broader spirit and scope of the inventive concepts described herein. For example, the techniques described herein can be modified and applied to generate any number of scenes from any number of input image tiles generated by the scene creation application 124 or provided by a user.

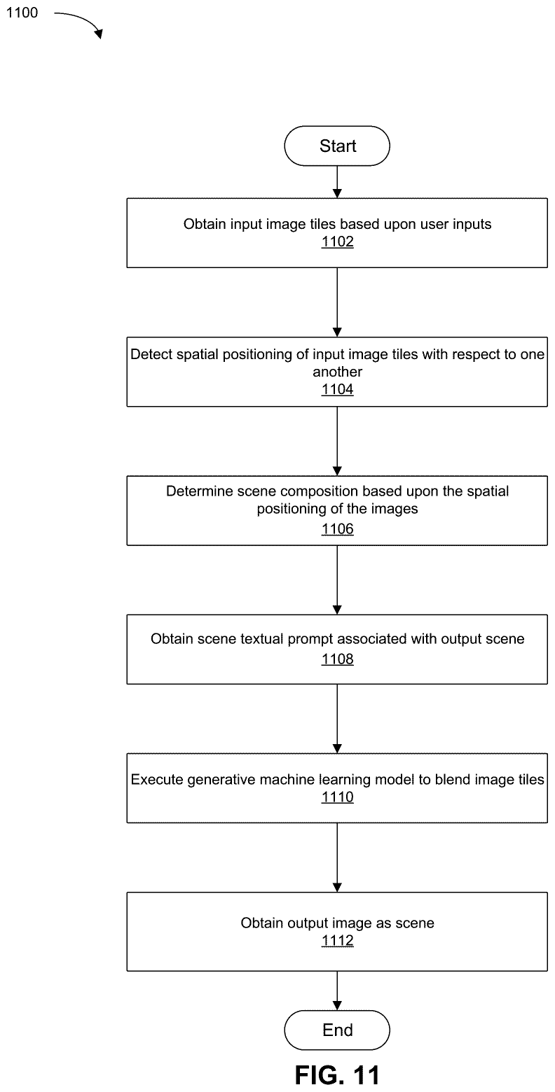

FIG. 11 set forth a flow diagram of method steps for generating a scene based upon user inputs, according to various embodiments. Although the method steps are described with reference to the systems of FIG. 1, persons skilled in the art will understand that any system configured to implement the method steps, in any order, falls within the scope of the embodiments.

As shown, a method 1100 begins at step 1102, where the scene creation application 124 can obtain input image tiles based upon user inputs. The input image tiles can be used to generate a scene on behalf of the user by utilizing the generative machine learning model 132. Respective input image tiles can be uploaded to or provided by the user. Respective image tiles can also be generated using the scene creation application 124 with the assistance of the generative machine learning model 132.

The scene creation application 124 can obtain a textual prompt, a user sketch, a region designation of a blank canvas or user sketch, or combinations thereof. These user inputs can be provided to the generative machine learning model 132, which can be executed by the scene creation application 124 to generate an output image that can be presented to the user as an image tile. The user can generate multiple image tiles that can be utilized by the scene creation application 124 to generate a scene on behalf of the user.

At step 1104, the scene creation application 124 can determine the spatial relationship of the image tiles with respect to one another. The scene creation application 124 can allow the user to resize, arrange, or move the image tiles identified at step 1102. The spatial relationship of the image tiles with respect to one another can be identified by mapping coordinates of the image tiles with respect to each other, such as on a cartesian map. For example, a bitmap can be generated that specifies the coordinates of respective image tiles with respect to each other.

At step 1106, a scene composition can be determined based upon the spatial relationship of the image tiles with respect to one another. A scene composition can comprise the spatial relationship of the image tiles with respect to each other along with whitespace between the respective image tiles. The scene creation application 124 can utilize the whitespace to blend the image tiles together to generate a scene.

At step 1108, the scene creation application 124 can obtain a scene textual prompt associated with a resultant output scene. The scene textual prompt can be a descriptive natural language prompt provided by the user that can specify a desired characteristic of the scene.

At step 1110, the scene creation application 124 can execute a generative machine learning model 132, providing the input image tiles, the scene composition, and the scene textual prompt as inputs to the generative machine learning model 132. The scene creation application 124 can request the generative machine learning model 132 to generate one or more output images based upon the provided inputs. The one or more output images can be candidates for a scene generated based upon the provided inputs.

The scene creation application 124 can generate the output image corresponding to a scene by filling the white space between the image tiles and blending the tiles together. For blending image tiles, the scene creation application 124 can, for example, obtain a binary mask with black pixels for image tiles and white pixels for empty space. A Gaussian blur can be applied to the mask, softening black tile edges for a smooth blend. The final image corresponding to a scene can be generated by inputting the mask and user-created image tiles as inputs to the generative machine learning model 132.

At step 1112, the scene creation application 124 can obtain the one or more output images from the generative machine learning model 132 as the scene generated by the scene creation application 124.

The method 1100 then terminates.

In sum, techniques are disclosed for generating scenes, such as scenes associated with a fictional world created by an artist or author, using a computer-aided design tool. Input image tiles can be provided by the user or generated by the design tool based upon textual prompts provided by the user, user-provided sketches, or combinations thereof. Image tiles can then be arranged using a GUI such that a spatial relationship between the image tiles can be identified. The spatial relationship of the image tiles corresponds to a scene composition. From the scene composition, the input image tiles, and a scene textual prompt, an output image can be generated by a generative machine learning model. The output image corresponds to a scene.

At least one technical advantage of the disclosed techniques relative to the prior art is that the disclosed techniques enable users with limited time or knowledge of computer-aided design tools or generative tools to generate scenes of a fictional world more effectively and efficiently. In that regard, the disclosed techniques provide an automated process for obtaining multiple image tiles that can be used as the basis for generating a scene of a fictional world. The image tiles can be provided by a user or created using a machine learning model that is provided a user input, such as a textual prompt, a sketch, a region map based upon user-designated regions of an image tile, or any combination thereof. The machine learning model can generate one or more image tiles based upon the user input from a spatial relationship of the image tiles with respect to one another and a textual scene prompt obtained from a user.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory, Flash memory, an optical fiber, a portable compact disc read-only memory, an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a scene, the method comprising:
obtaining a plurality of input image tiles based upon at least one user input;
detecting a spatial positioning of each input image tile included in the plurality of input image tiles relative to at least one other input image tile included in the plurality of input image tiles;
determining a scene composition of the scene based upon the spatial positioning of each input image tile included in the plurality of image tiles;
obtaining a scene prompt associated with the scene; and
causing a machine learning model to blend the plurality of image tiles based upon the scene prompt to generate the scene.

2. The computer-implemented method of claim 1, wherein the scene prompt comprises a textual prompt indicating how the plurality of image tiles should be blended to generate the scene.

3. The computer-implemented method of claim 1, wherein obtaining the plurality of input image tiles based upon the at least one user input comprises:
obtaining an image tile textual prompt that describes a desired characteristic of a corresponding image tile included in the plurality of image tiles;
providing the image tile textual prompt to the machine learning model; and
executing the machine learning model to generate the corresponding image tile based upon the textual prompt.

4. The computer-implemented method of claim 1, wherein obtaining the plurality of input image tiles based upon the at least one user input comprises:
obtaining within a graphical user interface a sketch of a portion of the scene;
providing the sketch to the machine learning model; and
executing the machine learning model to generate a corresponding image tile based upon the sketch.

5. The computer-implemented method of claim 1, further comprising:
obtaining within a graphical user interface a sketch of a portion of the scene;
obtaining an image tile textual prompt associated with the sketch of the portion of the scene, wherein the image tile textual prompt specifies a desired characteristic of the respective image tile; and
executing the machine learning model to generate the respective image tile based upon the sketch and the image tile textual prompt.

6. The computer-implemented method of claim 1, wherein obtaining the plurality of input image tiles based upon the at least one user input comprises:
obtaining within a graphical user interface a designation of a region of a corresponding image tile;
obtaining a region textual prompt that corresponds to the region, wherein the region textual prompt specifies a desired characteristic of the region within the respective image tile; and
executing the machine learning model to generate the corresponding image tile based upon the region and the region textual prompt.

7. The computer-implemented method of claim 1, wherein obtaining the plurality of input image tiles based upon at least one user input comprises:
obtaining a selection of a previously generated image tile included in the plurality of previously generated image tiles;
generating a new image tile based upon a user input;
obtaining a textual prompt specifying a desired characteristic for a combined image tile; and
executing the machine learning model to generate the combined image tile based upon the desired characteristic, the previously generated image tile, and the new image tile.

8. The computer-implemented method of claim 1, further comprising:
obtaining, within a graphical user interface, the spatial positioning of each input image tile included in the plurality of input image tiles relative to at least one other input image tile included in the plurality of input image tiles, wherein the spatial positioning comprises whitespace between at least a first input image tile included in the plurality of image tiles and a second input image tile included in the plurality of input image tiles.

9. The computer-implemented method of claim 8, further comprising automatically adjusting an amount of whitespace between each input image tile included in the plurality of input image tiles relative to at least one other input image tile included in the plurality of input image tiles.

10. The computer-implemented method of claim 8, wherein executing the first machine learning model to blend the plurality of image tiles to form the scene based upon the scene prompt comprises filling the whitespace between the at least one of the plurality of image tiles based upon the scene prompt.

11. One or more non-transitory computer readable media including instructions that, when executed by one or more processors, cause the one or more processors to generate a scene by performing the steps of:
obtaining a plurality of input image tiles based upon at least one user input;
detecting a spatial positioning of each input image tile included in the plurality of input image tiles relative to at least one other input image tile included in the plurality of input image tiles;
determining a scene composition of the scene based upon the spatial positioning of each input image tile included in the plurality of image tiles;
obtaining a scene prompt associated with the scene; and
causing a machine learning model to blend the plurality of image tiles based upon the scene prompt to generate the scene.

12. The one or more non-transitory computer readable media of claim 11, wherein the scene prompt comprises a textual prompt indicating how the plurality of image tiles should be blended to generate the scene.

13. The one or more non-transitory computer readable media of claim 11, wherein obtaining the plurality of input image tiles based upon the at least one user input comprises:
obtaining an image tile textual prompt that describes a desired characteristic of a corresponding image tile included in the plurality of image tiles;
providing the image tile textual prompt to the machine learning model; and
executing the machine learning model to generate the corresponding image tile based upon the textual prompt.

14. The one or more non-transitory computer readable media of claim 11, wherein the method comprises:
obtaining within a graphical user interface a sketch of a portion of the scene;
providing the sketch to the machine learning model; and
executing the machine learning model to generate a corresponding image tile based upon the sketch.

15. The one or more non-transitory computer readable media of claim 14, further comprising:
obtaining within a graphical user interface a sketch of a portion of the scene;
obtaining an image tile textual prompt associated with the sketch of the portion of the scene, wherein the image tile textual prompt specifies a desired characteristic of the respective image tile; and
executing the machine learning model to generate the respective image tile based upon the sketch and the image tile textual prompt.

16. The one or more non-transitory computer readable media of claim 11, wherein obtaining the plurality of input image tiles based upon the at least one user input comprises:
obtaining within a graphical user interface a designation of a region of a corresponding image tile;
obtaining a region textual prompt that corresponds to the region, wherein the region textual prompt specifies a desired characteristic of the region within the respective image tile; and
executing the machine learning model to generate the corresponding image tile based upon the region and the region textual prompt.

17. The one or more non-transitory computer readable media of claim 11 wherein obtaining the plurality of input image tiles based upon at least one user input comprises:
obtaining a selection of a previously generated image tile included in the plurality of previously generated image tiles;
generating a new image tile based upon a user input;
obtaining a textual prompt specifying a desired characteristic for a combined image tile; and
executing the machine learning model to generate the combined image tile based upon the desired characteristic, the previously generated image tile, and the new image tile.

18. The one or more non-transitory computer readable media of claim 11, wherein the method comprises:
obtaining, within a graphical user interface, the spatial positioning of each input image tile included in the plurality of input image tiles relative to at least one other input image tile included in the plurality of input image tiles, wherein the spatial positioning comprises whitespace between at least a first input image tile included in the plurality of image tiles and a second input image tile included in the plurality of input image tiles.

19. The one or more non-transitory computer readable media of claim 18, wherein causing the machine learning model to blend the plurality of image tiles to form the scene based upon the scene prompt comprises filling the whitespace between the at least one of the plurality of image tiles based upon the scene prompt.

20. A system comprising:
one or more memories storing instructions; and
one or more processors coupled to the one or more memories that, when executed, perform the steps of:
obtaining a plurality of input image tiles based upon at least one user input;
detecting a spatial positioning of each input image tile included in the plurality of input image tiles relative to at least one other input image tile included in the plurality of input image tiles;
determining a scene composition of the scene based upon the spatial positioning of each input image tile included in the plurality of image tiles;
obtaining a scene prompt associated with the scene; and
causing a machine learning model to blend the plurality of image tiles based upon the scene prompt to generate the scene.
